(19) United States
(12) Patent Application Publication
(10) Pub. No.: US 2026/0352070 A1
(43) Pub. Date: Nov. 5, 2026

(54) BRUSHLESS DC MOTOR

(71) Applicant: TECHTRONIC CORDLESS GP, Anderson, SC (US)

(72) Inventors: Yung Fai Tsui, Hong Kong (CN); Kaiming Wei, Dongguan City (CN); Xiangyu Fang, Dongguan (CN); Guoan Zhang, Dongguan (CN)

(21) Appl. No.: 19/136,225

(22) PCT Filed: May 26, 2023
(86) PCT No.: PCT/CN23/96518

§ 371 Date: Jun. 5, 2025

(51) Int. Cl. H02K 11/215; H02K 7/14; H02K 21/16

(52) U.S. Cl. CPC H02K 11/215; H02K 7/145; H02K 21/16; H02K 2211/03

(57) ABSTRACT

A brushless DC motor may include an elongate motor shaft. A brushless DC motor may include a rotor comprising including a plurality of magnets fixed about said the elongate motor shaft. A brushless DC motor may include a stator assembly arranged about the rotor, said the stator assembly comprising including a plurality of windings supported on a stator; and a circuit board attached to an end of the stator, said the circuit board including a plurality of slots receiving a winding portion therein, wherein one or more strain relief projections extends from the stator proximate at least one of said the plurality of slots for bearing against at least a portion of a winding wound thereabout.

### CROSS-REFERENCE TO RELATED APPLICATIONS

This application is a national phase filing under 35 U.S.C. § 371 of International Application No. PCT/CN2023/096518 filed on May 26, 2023, the entire content of which is incorporated by reference herein.

### FIELD OF THE DISCLOSURE

The present disclosure relates to electrical motors, in particular to a brushless direct current (BLDC) motor, a stator suitable for use in said motor, a tool using such motor and a method of manufacturing such a motor.

### BACKGROUND OF THE DISCLOSURE

Battery operated motors in power tools are typically arranged to rotate a shaft to which the tool is attached, relying on electromagnetic interactions which occur between the windings and a permanent magnet in the motor. In permanent magnet brushed DC motors, windings are wound about a magnetisable core (rotor) which rotates inside a fixed permanent magnet (stator). Windings receive current via brushes and commutators and are hence referred to as brushed DC motors.

In an alternative arrangement, namely brushless DC motors, the stator windings encircle an internal permanent magnet rotor. Brushless DC motors typically are more durable than brushed motors, with a higher speed and torque performance. Furthermore, brushless DC motors typically produce less noise and have a longer lifetime.

In brushless DC motors, the switching of the current in the encircling stator windings drives rotation of the rotor and attached shaft. The injection of electrical current into successive stator coils produces changing electro-magnetic poles on the stator periphery. These changing poles of the stator coils are energised in sequence to attract the opposite pole on the rotor, producing torque and rotation of the motor shaft which is in turn used to drive the driven member of the power tool.

As is known in the art, in the operation of brushless DC motors, it is critical to ensure synchronisation of the rotating magnetic pole produced by energizing the stator coils and the rotating magnetic pole of the rotor. Typically sensors (e.g. Hall effect sensors) mounted on a sensor board attached to the stator are arranged to detect the location of the rotor magnetic pole relative to the coil windings. The detected location is then provide to a motor controller circuit for control of the current flow to the stator coils. Often a wire from the stator coil passes through a slot on the sensor board to the power source, being secured in the slot using a dollop of solder.

Unfortunately, in many cases in view of inherent different vibration frequencies of the stator body, and the sensor board during operation, the wire from the stator coil at the slot may become fatigued with prolonged operation, leading to eventual failure of the motor.

It is an object of the present disclosure to provide an alternative arrangement which addresses or at least partially ameliorates the above disadvantages or at least provides a further choice to the public.

### SUMMARY OF THE DISCLOSURE

The present disclosure provides, in one aspect, a brushless DC motor including: an elongate motor shaft; a rotor including a plurality of magnets fixed about the elongate motor shaft; a stator assembly arranged about the rotor, the stator assembly including a plurality of windings supported on a stator; and a circuit board attached to an end of the stator, the circuit board including a plurality of slots receiving a winding portion therein, wherein one or more strain relief projections extends from the stator proximate at least one of the plurality of slots for bearing against at least a portion of a winding wound thereabout.

In some aspects, the techniques described herein relate to a brushless DC motor including: an elongate motor shaft; a rotor including a plurality of magnets fixed about the elongate motor shaft; a stator assembly arranged about the rotor, the stator assembly including a plurality of windings supported on a stator, wherein the stator includes mounting portions for receiving a fastener for engagement with a circuit board, the mounting portions being disposed between a pair of adjacent windings extending from the stator; and a circuit board attached to an end of the stator, the circuit board including a plurality of slots receiving a winding portion therein.

The present disclosure provides, in another aspect, a stator for a brushless DC motor including: one or more strain relief projections arranged to extend from an end of the stator proximate one or more corresponding slots of a circuit board to which the stator is engageable, the one or more strain relief projections bearing against at least a portion of a winding of a plurality of windings wound thereabout; and a plurality of mounting portions configured to receive fasteners for engagement with a circuit board, each of the mounting portions being disposed between a pair of adjacent windings extending from the stator.

### BRIEF DESCRIPTION OF THE DRAWINGS

FIG. 1A is an exploded perspective view of a brushless DC motor.

FIG. 1B is a perspective view of the hall sensor board and the stator of a brushless DC motor assembly.

FIG. 1C is a perspective view of a broken connection between the stator wire and circuit board.

FIG. 2A is an exploded perspective view of a brushless DC motor.

FIG. 2B is an exploded perspective view of a brushless DC motor.

FIG. 2C is a perspective view of the hall sensor board and the stator of FIG. 2A or FIG. 2B.

FIG. 2D is an enlarged perspective view of a strain relief projection and end retention member of the stator of FIG. 2A.

FIG. 2E is an enlarged perspective view of a strain relief projection and end retention member of the stator of FIG. 2B.

FIG. 2F is an exploded perspective view of fasteners, sensor board, a portion of the windings and the stator of FIG. 2A.

FIG. 3A is a schematic side view of an embodiment of a strain relief projection.

FIG. 3B is a schematic side view of another embodiment of a strain relief projection.

FIG. 4A is a perspective view of a tool in which a brushless DC motor is disposed.

FIG. 4B is an enlarged perspective view of a portion of the brushless DC motor of FIG. 4A.

Before any embodiments of the subject matter are explained in detail, it is to be understood that the subject matter is not limited in its application to the details of construction and the arrangement of components set forth in the following description or illustrated in the following drawings. The subject matter is capable of other embodiments and of being practiced or of being carried out in various ways. Also, it is to be understood that the phraseology and terminology used herein is for the purpose of description and should not be regarded as limiting.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without departing from the scope of the present disclosure.

The disclosed technology addresses the need in the art for an improved brushless DC motor which addresses or at least ameliorates some of the deficiencies of the prior art.

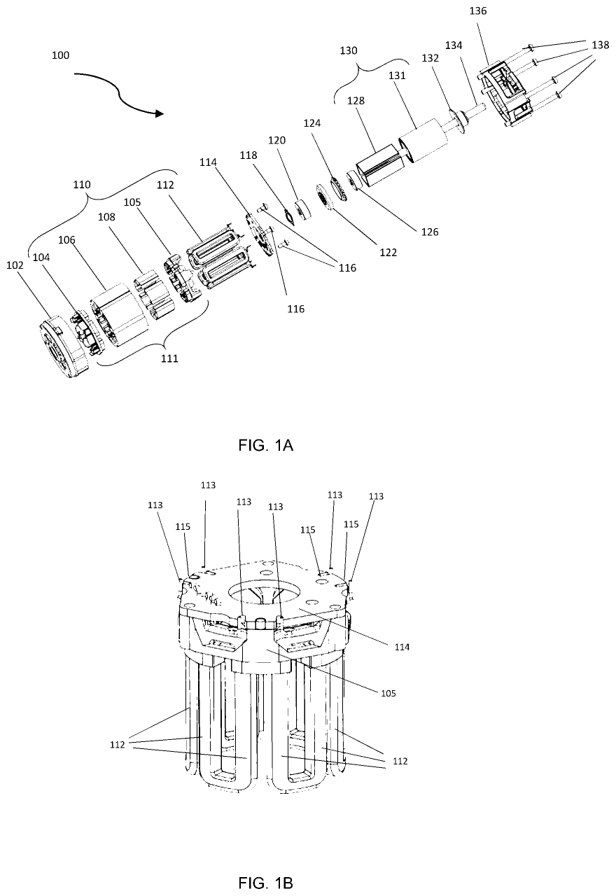

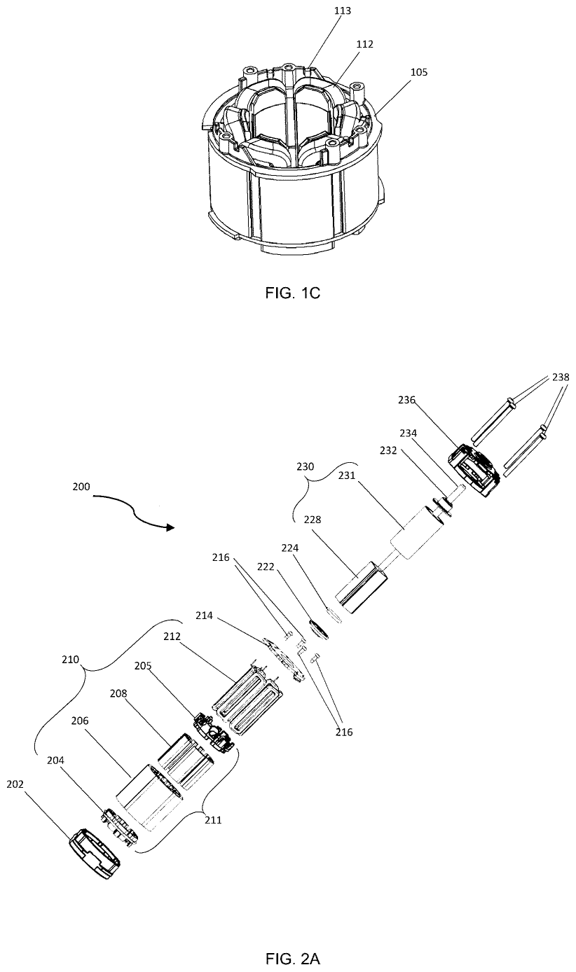

FIG. 1A depicts an exploded perspective view of various components of a brushless DC motor according to a conventional design.

As depicted in the embodiment of the present disclosure shown in FIG. 1A, a front cap 102 receives a front coil retainer 104 into which the stator stack 106 and insulation paper 108 are also received. The stator assembly 110 comprises the front coil retainer 104, rear coil retainer 105 and stator stack assembly 106 together with the windings 112. The stator 111 comprises the front coil retainer 104, rear coil retainer 105 and stator stack 106.

A printed circuit board (PCB) 114 (typically with Hall-effect type sensors) is attachable to the rear coil retainer 105 of the stator 111 via fasteners 116. Often although not exclusively such fasteners may be screws or similar which are engaged into corresponding threaded portions included in the rear coil retainer 105. Generally, these screws extend through holes 117 (not shown) on the circuit board 114 wherever may be convenient based on the design of the circuit.

The rotor assembly 130 (including magnets 128 arranged about elongate shaft 134 and rotor lamination stack 131) is supported by various components on the front side of the motor. Typically these components include a wave washer 118, ball bearings 120, 126, a front balance washer 122 and a rubber ring 124 although other arrangements may also be used. The rotor assembly 130 is also supported at the rear of the motor by a rear balance washer 132.

In the conventional motor 100 depicted in FIG. 1A, the rotor assembly 130, elongate shaft 134 and stator assembly 110 are hence received and supported between the front cap 102 and rear cap 136, secured together by screws or other fasteners 138. It would be appreciated that other arrangements of the prior art brushless motors which do not include front cap 102 and rear cap 136 are also used although are not depicted.

FIG. 1B depicts an enlarged perspective view of the hall sensor board and the stator of the conventional brushless DC motor assembly of FIG. 1A. For ease of reference, this enlarged view depicts the conventional arrangement of brushless DC motors where the windings 112 are received in slots 115 of the printed circuit board 114.

It would be appreciated that the ends 113 of the windings 112 have been truncated in the figure, eventually these are connected to the motor controller (not shown) for connection to a power source.

As depicted, the ends 113 of windings 112 are supported on the stator 111 and pass directly above to extend through corresponding slots 115 defined in the circuit board 114. Typically the windings are secured in these slots with a dollop solder (not shown).

Referring now to FIG. 1C, there is depicted an enlarged perspective view of a broken connection between the stator wire and circuit board. The winding end 113 has been sheared away from the other portion of the winding which is retained in the slot 115 of the PCB 114 (not shown for clarity) by a small amount of solder.

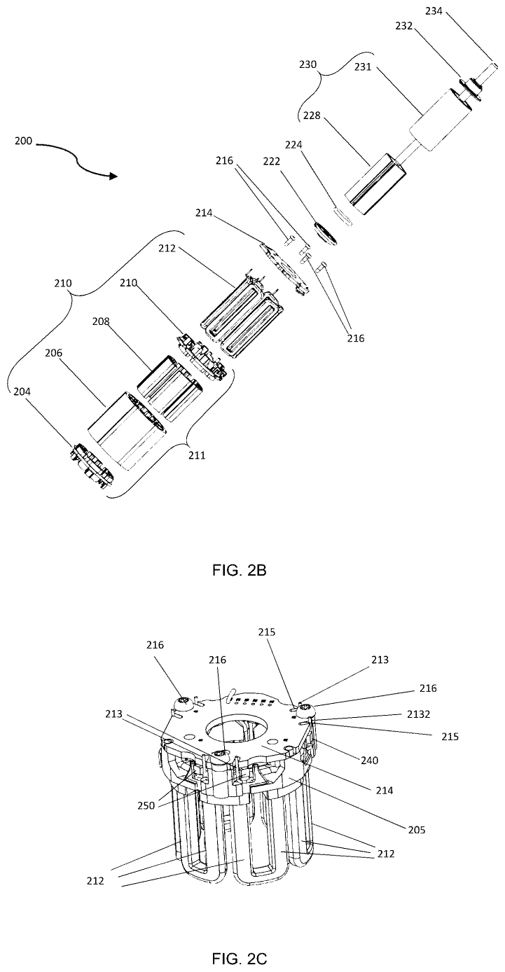

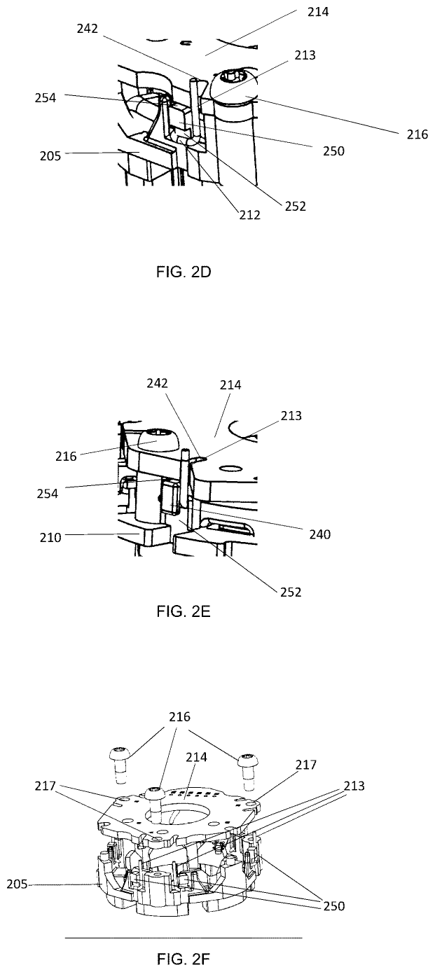

FIG. 2A depicts an exploded perspective view of various components of a brushless DC motor according to an improved design according to an embodiment of the subject matter. It is noted that this arrangement includes a pair of end caps which are used to secure the components of the motor.

Similar to the arrangement depicted in FIG. 1A, there is shown a front cap 202 which receives a front coil retainer 204 into which the stator stack 206 and insulation paper 208 are also received. The stator assembly 210 comprises the front coil retainer 204, rear coil retainer 205 and stator stack 206 of the stator 211 and together with the windings 212. The stator 211 comprises the front coil retainer 204, rear coil retainer 205 and stator stack 206.

A printed circuit board 214 (typically with Hall-effect type sensors) is attachable to the rear coil retainer 205 of the stator 211 via fasteners 216. Such fasteners may be screws or similar which are engaged into corresponding threaded portions included in the rear coil retainer 205. These screws extend through holes 217 (not shown) on the circuit board 214.

The rotor assembly 230 (including magnets 228 arranged about shaft 234 and rotor lamination stack 231) is supported by various components on the front side of the motor. Typically these components include a wave washer 218 (not shown), ball bearings 220, 226 (not shown), a front balance washer 222 and a rubber ring 224 although other arrangements may also be used. The rotor assembly 230 is also supported at the rear of the motor by a rear balance washer 232.

In the motor 200 depicted in FIG. 2A, the rotor assembly 230, shaft 234 and stator 211 are hence received and supported between the front cap 202 and rear cap 236, secured together by screws or other fasteners 238.

FIG. 2B depicts an exploded perspective view of various components of a brushless DC motor according to an improved design according to a further embodiment of the subject matter.

Essentially the embodiment depicted in FIG. 2B is the same as the embodiment in FIG. 2A, apart from the absence of end cap members 202, 236 and a change in the shape of the strain relief projection 250 which is detailed further below.

FIG. 2C depicts an enlarged perspective view of the hall sensor board and the stator of the brushless DC motor assembly of FIG. 2A and/or FIG. 2B.

It can be seen from the enlarged view that the windings 212 are received in slots 215 of the printed circuit board 214. (Some numerals for certain slots/windings have been omitted for clarity purposes). It would be appreciated that the ends of the windings 212 have been truncated in the figure, eventually these are connected to the motor controller (not shown) for connection to a power source.

As depicted, the windings 212 are supported on the stator 211 and pass from the stator about a strain relief projection 250 formed on the rear coil retainer 205. As shown, the strain relief projection 250 extends or projects outwardly and away from the elongate shaft 234 (not shown) as shown in more detail in FIGS. 2D-2F.

The strain relief projection 250 is disposed so that the path of the winding 212 as it exits the stator assembly 210 when assembled is not directly straight above through the slot 215 of the circuit board 214 as it is in the conventional prior art arrangements. Instead, in an arrangement according to the present disclosure, the winding exits from the stator, bends, and bears against the strain relieving projection to bear about the projection and then extends upwardly through the slot 215 of the circuit board 214.

Hence, in manufacturing the motor, the winding is at least partially wound about the strain relieving member 250.

During operation, the positioning of the strain relief member 250 relative to the slot and the winding on the stator means that the forces arising from the differences in vibration frequency of the stator and the circuit board are no longer solely acting on the solder joint, but also act on the strain relief projection. The winding has the ability to deform and move slightly about the strain relieving member 250. This increases the longevity of the motor as fatigue in the winding is avoided.

FIG. 2D depicts an enlarged perspective view of an exemplary strain relieving member and end retention member of the stator.

As depicted the strain relief projections may be generally L shaped arrangement with a first body portion 252 extending in the direction parallel to the longitudinal axis of the elongate shaft; and an arm portion 254 extending radially outwardly from the elongate shaft. This arrangement is especially suited smaller motors or shorter motors where the stator winding coils have a small diameter.

FIG. 2E depicts an enlarged perspective view of an exemplary strain relief projection (in this arrangement it is U shaped) of the stator.

FIG. 2F depicts a perspective view of exemplary sensor board 214 and the end of the stator 211, in particular the rear coil retainer 205.

In the embodiment depicted, three equidistant apertures 217 are disposed between each adjacent pair of slots 215 disposed in the periphery of said sensor board 214 in which the windings from the stator are received. As shown there are three fasteners (in this case screws) 216, which are configured to engage the sensor board 214 with the stator 211. The slots 215 in the circuit board 214 are located on either side of the apertures 217 for the screws 216.

It should be noted that the apertures for the fasteners for the circuit board 214 may be defined proximate to and between the slots of the circuit board in combination with the strain relief projections which extend from the stator described herein.

Alternatively, the apertures 217 for the fasteners for the circuit board 214 may be defined proximate to and between each pair of slots of the circuit board as an alternative to the strain relief projections which extend from the stator described herein. In either arrangement, the location of the apertures close to the slots 215 reduces the force and displacement on the windings by minimising the moment generated by differences in relative vibration of the stator assembly 210 and the circuit board 214.

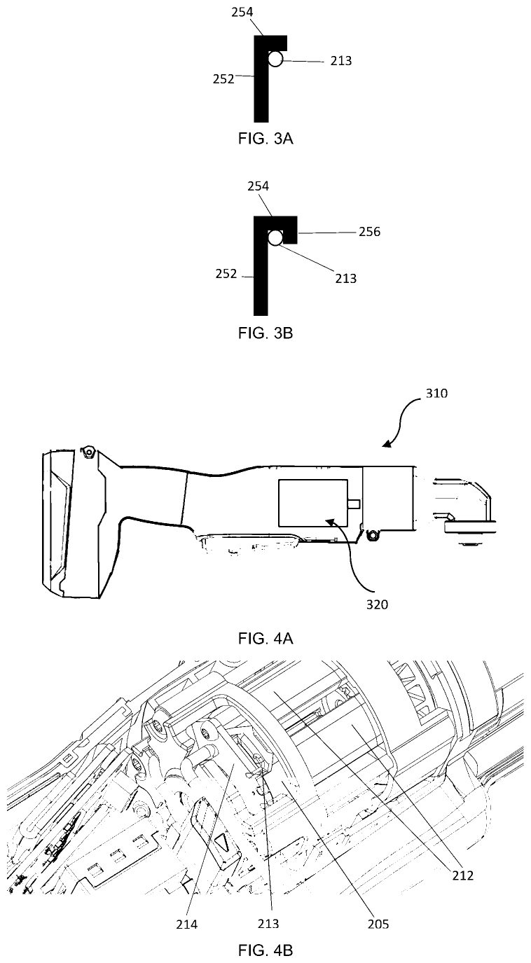

FIG. 3A depicts a schematic side view of an exemplary strain relief projection.

As depicted the winding includes an end portion 213 which contacts with the strain relief projection 250. In particular, as depicted the strain relief projection may be generally L shaped arrangement with a first body portion 252 extending in the direction parallel to the longitudinal axis of the elongate shaft, and an arm portion 254 extending radially outwardly from the elongate shaft. This arrangement is especially suited smaller motors where the stator winding coils have a small diameter and in which an end cap is not applied. Typically, although not exclusively such smaller motors may have a diameter of the stator stack 206 which is less than 38 mm.

FIG. 3B depicts a schematic side view of an alternate exemplary strain relief projection.

As depicted the winding includes an end portion 213 which contacts with the strain relief projection 250. In particular, as depicted the strain relief projection may be generally U shaped arrangement with a first body portion 252 extending in the direction parallel to the longitudinal axis of the elongate shaft, and an arm portion 254 extending radially outwardly from the elongate shaft. A second body portion 256 extends generally downwardly from the arm portion 254 in a direction arranged so as to be generally parallel to the elongate shaft. This arrangement is especially suited to larger diameter motors or longer motors where the stator winding coils have a large diameter and where an end cap may not be suitable, as the extra body portion 256 provides extra securing of the winding wound therethrough.

It would be appreciated by person skilled in the art that although both FIG. 3A and FIG. 3B depict the windings disposed at or near the junction of the arm and the body portion of the strain relief projection, other arrangements of the winding against the body portion and spaced further away from the junction of the arm and the body portion would also be possible without departing from the scope of the present disclosure.

FIG. 4A depicts an exemplary tool in which the brushless DC motor is disposed, while FIG. 4B depicts an enlarged portion thereof.

As depicted the tool 310 is an exemplary drill which includes a motor 320 comprising a stator assembly 330 and rotor assembly 340 and circuit board 350 (not shown) configured as hereinbefore described. It would be appreciated that other tools such as power saws, blowers or the like in which similar motors are disposed could also be used without departing from the scope of the present disclosure.

The arrangement of the apertures of the circuit board and the strain relieving members either together or separately have led to demonstrate increases in the lifespan of the brushless DC micro-sized motors (e.g. with a diameter from 30 mm to 60 mm). However, it would be appreciated that the teaching of the present disclosure are not limited to this application, and are suitable for use with larger motors.

The above embodiments are described by way of example only. Many variations are possible without departing from the scope of the disclosure as defined in the appended claims.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A brushless DC motor comprising:
an elongate motor shaft;
a rotor including a plurality of magnets fixed about the elongate motor shaft;
a stator assembly arranged about the rotor, the stator assembly including a plurality of windings supported on a stator; and
a circuit board attached to an end of the stator, the circuit board including a plurality of slots receiving a winding portion therein,
wherein one or more strain relief projections extends from the stator proximate at least one of the plurality of slots for bearing against at least a portion of a winding wound thereabout.

2. The brushless DC motor of claim 1, wherein a portion of the one or more strain relief projections extends radially outwardly relative to the elongate motor shaft and is positioned offset on a path between a slot and corresponding winding of the stator assembly received therein.

3. The brushless DC motor of claim 1, wherein a portion of the one or more strain relief projections extends downwardly and toward the end of the stator.

4. The brushless DC motor of claim 1, wherein the one or more strain relief projections extend in an L shape from the end of the stator.

5. The brushless DC motor of claim 1 wherein the one or more strain relief projections extend in at least a partial U shape from the end of the stator.

6. The brushless DC motor of claim 1 wherein the circuit board is attached to the end of the stator by fasteners disposed proximate to and between an adjacent pair of the plurality of slots.

7. The brushless DC motor of claim 6 wherein the fasteners are equidistantly located about the circuit board for attachment of the circuit board to the stator.

8. The brushless DC motor of claim 6, wherein the fasteners are screws.

9. The brushless DC motor of claim 6, wherein the circuit board is attached to the end of the stator by three equidistantly spaced screws disposed between adjacent slots disposed in a periphery of the circuit board.

10. The brushless DC motor of claim 1, wherein the circuit board is a sensor board.

11. A brushless DC motor comprising:
an elongate motor shaft;
a rotor including a plurality of magnets fixed about the elongate motor shaft; and
a stator assembly arranged about the rotor, the stator assembly including a plurality of windings supported on a stator, wherein the stator includes mounting portions for receiving a fastener for engagement with a circuit board, the mounting portions being disposed between a pair of adjacent windings extending from the stator,
wherein the circuit board is attached to an end of the stator, and wherein the circuit board includes a plurality of slots receiving a winding portion therein.

12. The brushless DC motor of claim 11, wherein each of the mounting portions is configured for receiving a screw therein.

13. The brushless DC motor of claim 11, further including one or more strain relief projections extending from the stator proximate at least one of the plurality of slots for bearing against at least a portion of a winding wound thereabout.

14. The brushless DC motor of claim 11, wherein the circuit board is a sensor board.

15. A stator for a brushless DC motor comprising:
one or more strain relief projections arranged to extend from an end of the stator proximate one or more corresponding slots of a circuit board to which the stator is engageable, the one or more strain relief projections bearing against at least a portion of a winding of a plurality of windings wound thereabout.

16. The stator of claim 15, wherein the one or more strain relief projections are configured to extend radially outwardly from the stator and offset from a path between the one or more corresponding slots and the corresponding windings wound about the stator upon assembly.

17. The stator of claim 15, wherein a portion of the one or more strain relief projections extends downwardly and toward the end of the stator.

18. The stator of claim 15, wherein the one or more strain relief projections extend in an L shape from the end of the stator.

19. The stator of claim 15, wherein the one or more strain relief projections extend in at least a partial U shape from the end of the stator.

20. The stator of claim 15, further comprising a plurality of mounting portions configured to receive a plurality of fasteners for engagement with the circuit board, each of the mounting portions being disposed between a pair of adjacent windings extending from the stator.

21. (canceled)

22. The stator of claim 15, wherein the circuit board is a sensor board.

23.-30. (canceled)
